(19) United States
(12) Patent Application Publication
(10) Pub. No.: US 2015/0371251 A1
(43) Pub. Date: Dec. 24, 2015

(54) REFERRAL REWARD TRACKING

(71) Applicant: Verizon Patent and Licensing Inc., Arlington, VA (US)

(72) Inventors: Sunil Limbasia, Irving, TX (US); Manah M. Khalil, Coppell, TX (US); Omar Abou-Khamis, Irving, TX (US)

(21) Appl. No.: 14/313,175

(22) Filed: Jun. 24, 2014

(51) Int. Cl. G06Q 30/02

(52) U.S. Cl. CPC G06Q 30/0214

(57) ABSTRACT

A method, a device, and a non-transitory storage medium to receive a referral request from a customer of a service provider; generate a referral code based on a receipt of the referral request; receive a message from the customer to a non-customer, wherein the message includes the referral code; store referral information included in the message, wherein the referral information includes a communication address of the non-customer, the referral code, and a communication address of the customer; receive a request from the non-customer to subscribe to a service offered by the service provider; request the referral code or a referent of the referral code from the non-customer; and use the referral code or the referent to assign a reward to the customer.

### BACKGROUND

A service provider may provide incentives to its existing customers for trying a new service or upgrading equipment. For example, the service provider may reduce the price of a new service or even allow the customer to try something for free during a limited trial period.

### BRIEF DESCRIPTION OF THE DRAWINGS

FIG. 1 is a diagram illustrating an exemplary environment in which exemplary embodiments of a referral service may be implemented;

FIGS. 2A-2G are diagrams illustrating exemplary embodiments of referral processes;

FIG. 3 is a diagram illustrating an exemplary table that stores referral information;

FIG. 4 is a diagram illustrating exemplary components of a device that may correspond to one or more devices in the environment depicted in FIG. 1; and

FIGS. 5 and 6 are flow diagrams illustrating exemplary referral processes.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

A service provider may offer a rewards program to its customers to entice their customers to use their service. For example, the service provider may provide a web site that allows customers to sign up for the rewards program. The rewards program may specify certain items or behaviors that will result in the awarding of points. For example, the service provider may award points to their customers when they order new equipment, renew a service contract, enroll in paper-free billing, upgrade service, etc. While the rewards program is a useful tool to incentivize existing customers' use of the service, it has limitations in that the service provider would like to expand their customer base as well.

According to an exemplary embodiment, a rewards program includes awarding customers that refer non-customers to the service provider and results in those non-customers subscribing to a service offered by the service provider. According to an exemplary embodiment, the rewards program includes awarding points to these customers. According to another exemplary embodiment, the rewards program includes awarding other types of benefits (e.g., discounts on equipment and/or services, a free trial of a new service, credit to a bill, a gift card, donation to a charity, etc.).

According to an exemplary embodiment, the rewards program is accessible via a network device. For example, the network device may be implemented as a web server device. According to an exemplary embodiment, a customer that wishes to refer a non-customer to use the service provider is able to do so via the network device. Alternatively, according to an exemplary embodiment, the customer may do so via various forms of communications (e.g., e-mail, social media (e.g., Facebook, Twitter, Google+, etc.), etc.) provided that the service provider receives a copy of the communication. For example, if a customer e-mails a friend requesting he or she use a service of the service provider, the customer may carbon copy (cc) the service provider using an e-mail address of the service provider.

According to exemplary embodiment, a referral process of the rewards program includes generating a referral code. The referral code serves, for example, as a referent to the customer. For example, the customer may visit the service provider's web site and request a referral code. According to an exemplary implementation, the customer enters his or her name, an e-mail address, or some other type of information and the web site generates the referral code based on or associated with the entered information. Thereafter, the customer may share the referral code via some form of communication with any non-customer.

According to an exemplary embodiment, the non-customer may use the referral code when signing up for a service provided by the service provider. For example, if the non-customer visits the web site, the web site allows the non-customer to provide the referral code as a part of the ordering process. As previously described, the service provider uses the referral code to identify the customer and confer a reward to the customer. Additionally, the service provider may use the referral code to confer a reward to the new customer.

There may be times, however, when the non-customer may have difficulty either remembering the referral code or retrieving the communication that included the referral code. According to an exemplary embodiment, the web site allows the non-customer to use other information, in place of the referral code. For example, the non-customer may enter his or her e-mail address that the customer used to communicate the referral code to the non-customer. In turn, the web site uses the non-customer's e-mail address as a key to correlate the non-customer with the customer. For example, the web site searches a database for the non-customer's email address. Once located, the web site correlates the non-customer's e-mail address to the customer's e-mail address and/or subscriber profile information. In this way, the benefit afforded under the rewards program may still be conferred to the customer and the new customer.

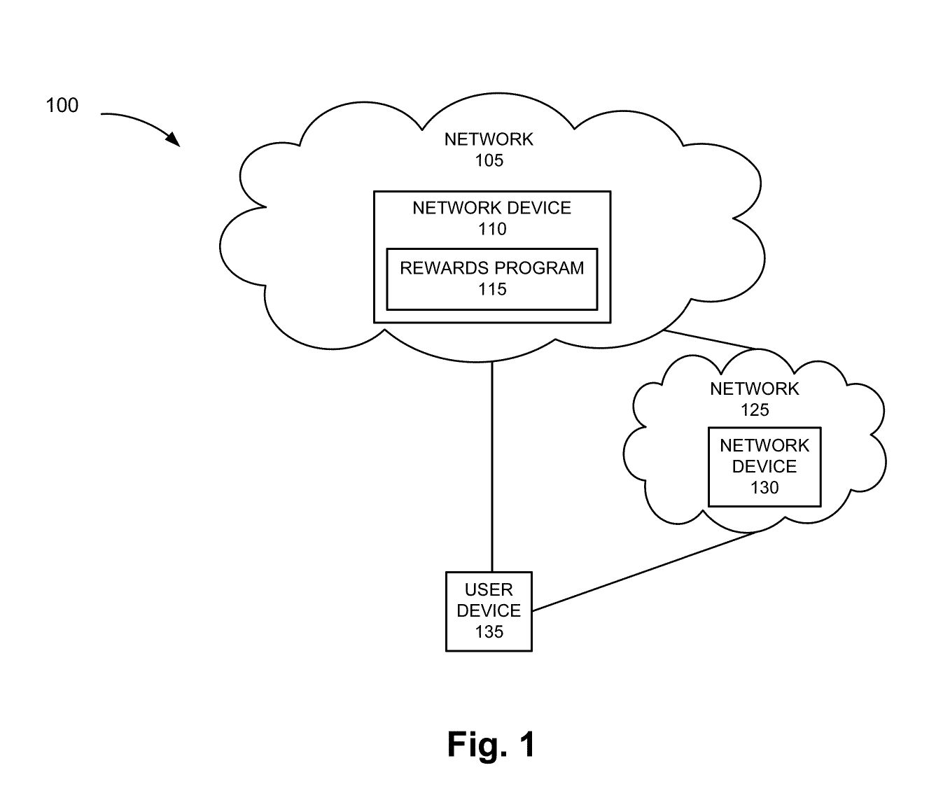

FIG. 1 is a diagram illustrating an exemplary environment 100 in which an exemplary embodiment of the rewards program may be implemented. As illustrated in FIG. 1, exemplary environment 100 includes a network 105 that includes a network device 110. Network device 110 provides a rewards program service 115. Environment 100 also includes a network 125 that includes a network device 130, as well as a user device 135.

Environment 100 may be implemented to include wired, optical, and/or wireless connections among the devices and the network illustrated. A connection may be direct or indirect and may involve an intermediary device and/or an intermediary network not illustrated in FIG. 1. Additionally, the number, type (e.g., wired, wireless, etc.), and the arrangement of connections between the devices and the networks are exemplary.

A device may be implemented according to a centralized computing architecture, a distributed computing architecture, or a cloud computing architecture (e.g., an elastic cloud, a private cloud, a public cloud, etc.). Additionally, a device may be implemented according to one or multiple network architectures (e.g., a client device, a server device, a peer device, a proxy device, and/or a cloud device).

The number of devices and configuration in environment 100 is exemplary and provided for simplicity. According to other embodiments, environment 100 may include additional devices, fewer devices, different devices, and/or differently arranged devices than those illustrated in FIG. 1. For example, according to other embodiments, there may be multiple network devices 110. For example, network devices 110 may include a web server device and a database management system (DBS) device.

Network 105 includes one or multiple networks of one or multiple types. For example, network 105 may include the Internet, a private network, a public network, a packet-switched network, a wired network (e.g., an optical network, a cable network, etc.), a wireless network (e.g., a mobile network, a cellular network, etc.), etc. Network 105 provides access to network device 110.

Network device 110 includes a computing device. For example, network device 110 may correspond to a server device. The server device may take the form of a web server, an application server, a virtual server, or some other type of network server. As illustrated, network device 110 includes rewards program element 115. Rewards program element 115 provides a rewards program, as described herein. According to an exemplary embodiment, rewards program service 115 provides a referral process, as described further below. According to an exemplary embodiment, the referral process includes rewarding a customer for referring a non-customer which results in the non-customer subscribing to or otherwise using or purchasing a service offered by the service provider. According to an exemplary embodiment, the referral process includes rewarding a new customer too.

Rewards program element 115 provides various user interfaces and logic, as described further below. Although not illustrated, network 105 may include various network devices, in addition to network device 110, such as, security devices, routing devices, gateways, access points, etc.

Network 125 includes one or multiple networks of one or multiple types. Network 125 provides access to network device 130. Network device 130 includes a computing device. For example, network device 130 may take the form of an e-mail server or a social media web site.

User device 135 may correspond to various types of end user devices. User device 135 may be a stationary device, a portable device, a handheld, a palmtop device, or a mobile device. For example, user device 135 may take the form of a computer (e.g., a desktop computer, a laptop computer, a palmtop computer, a tablet computer, a netbook, etc.), a personal digital assistant (PDA), a personal communication system (PCS) terminal, a smartphone, a Web or Internet access device, a set top box, or some other communication device (e.g., a vehicular infotainment system). User device 135 may include multiple devices (e.g., a set top box and a television, etc.).

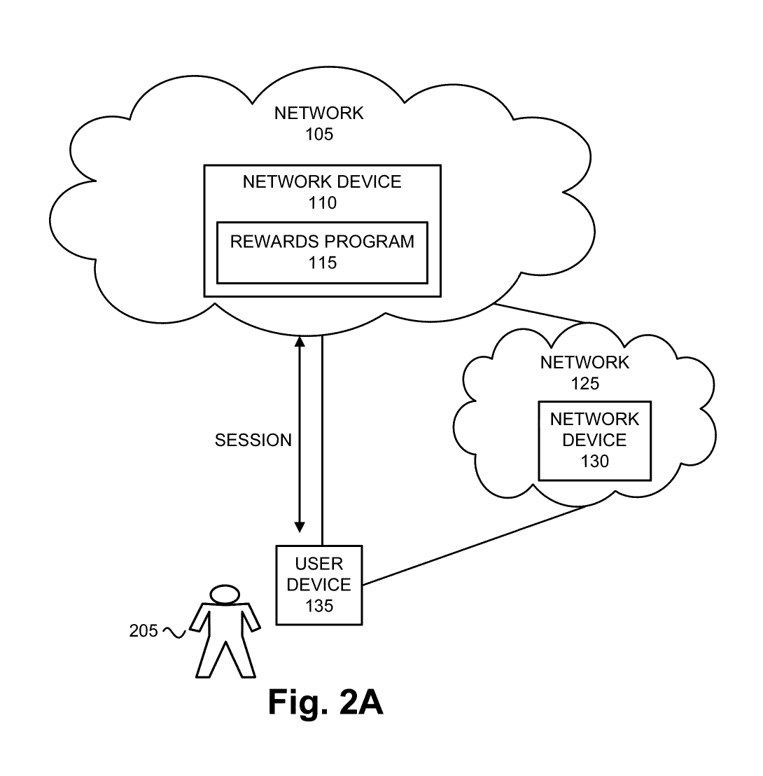

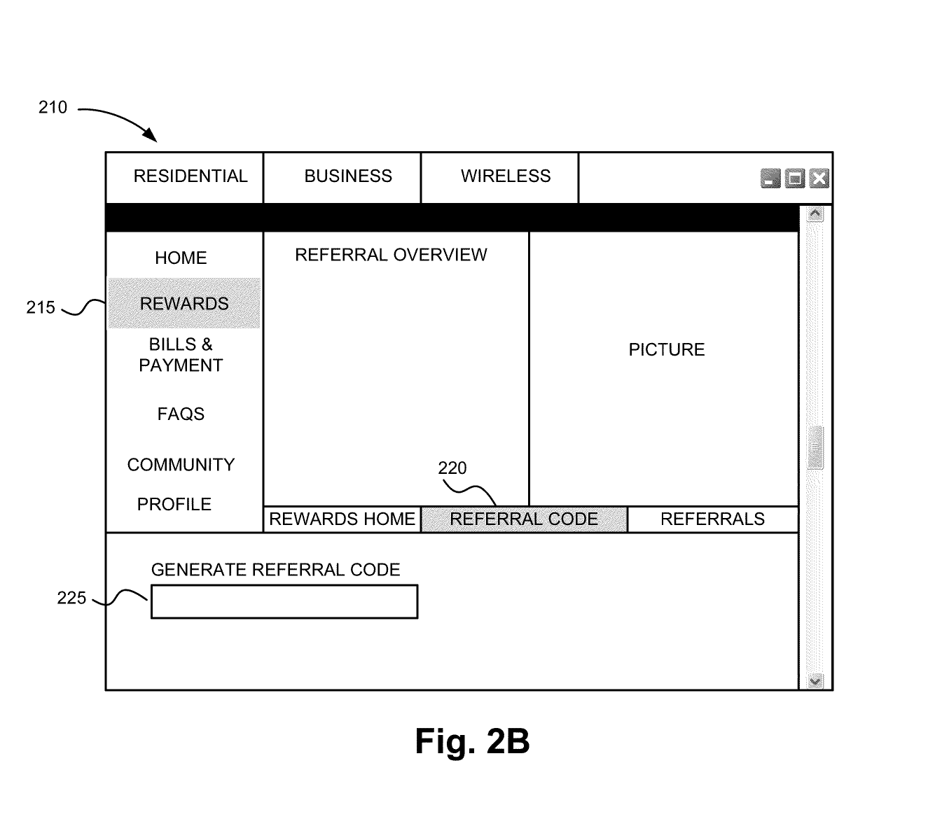

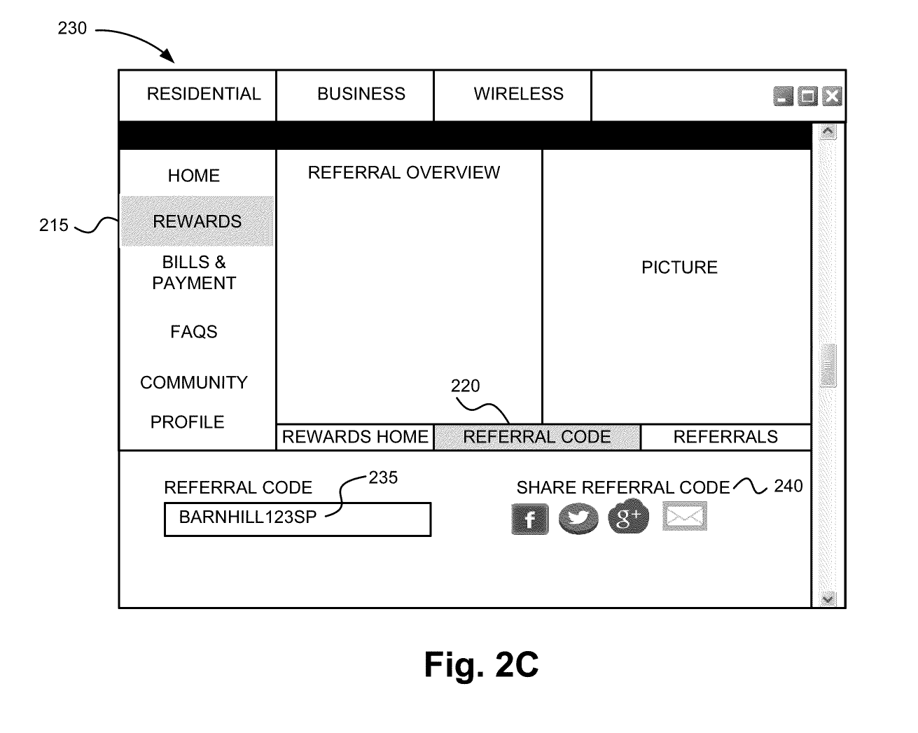

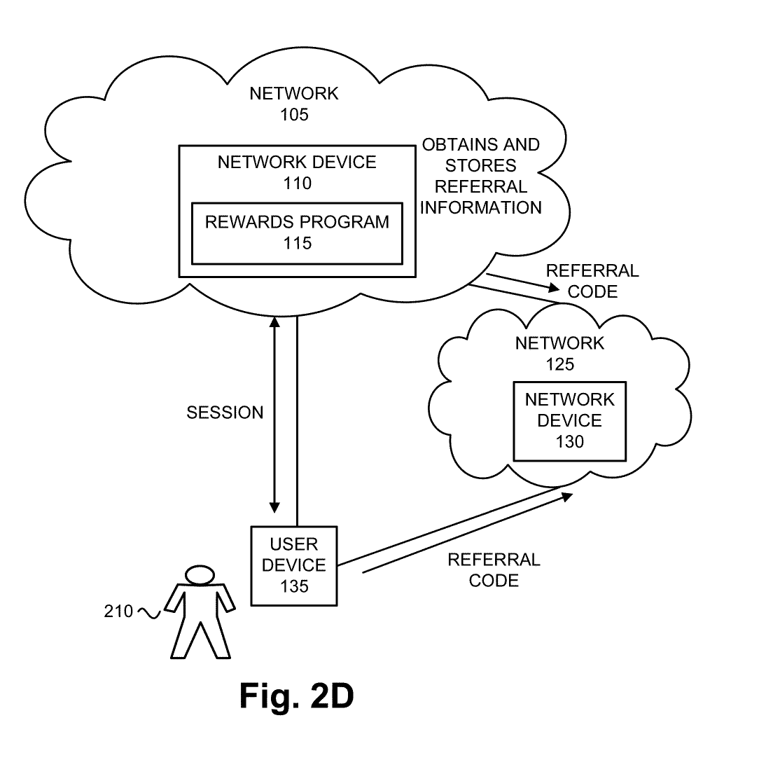

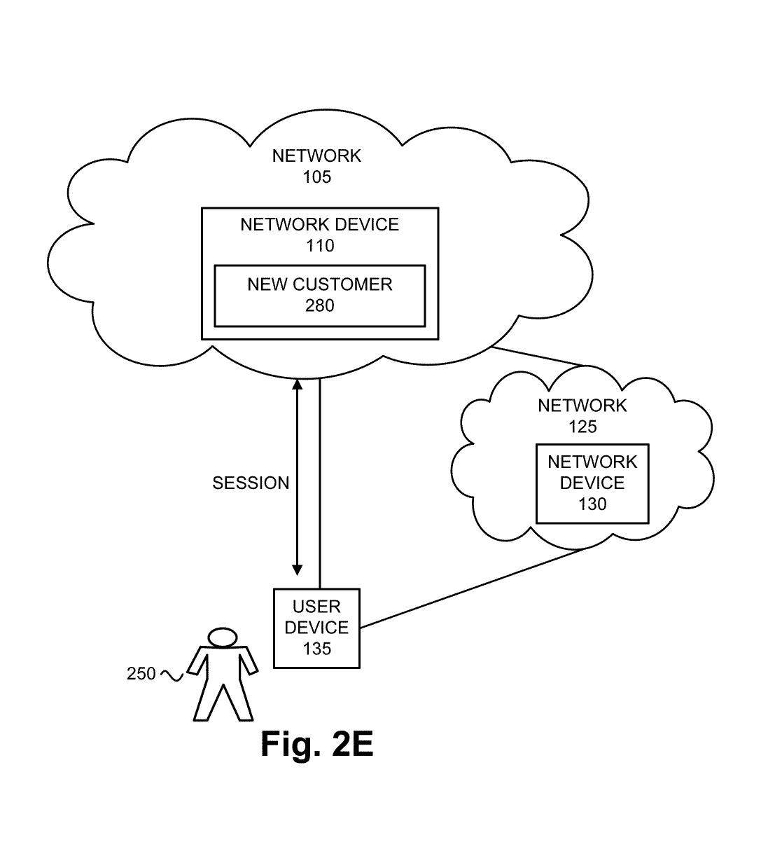

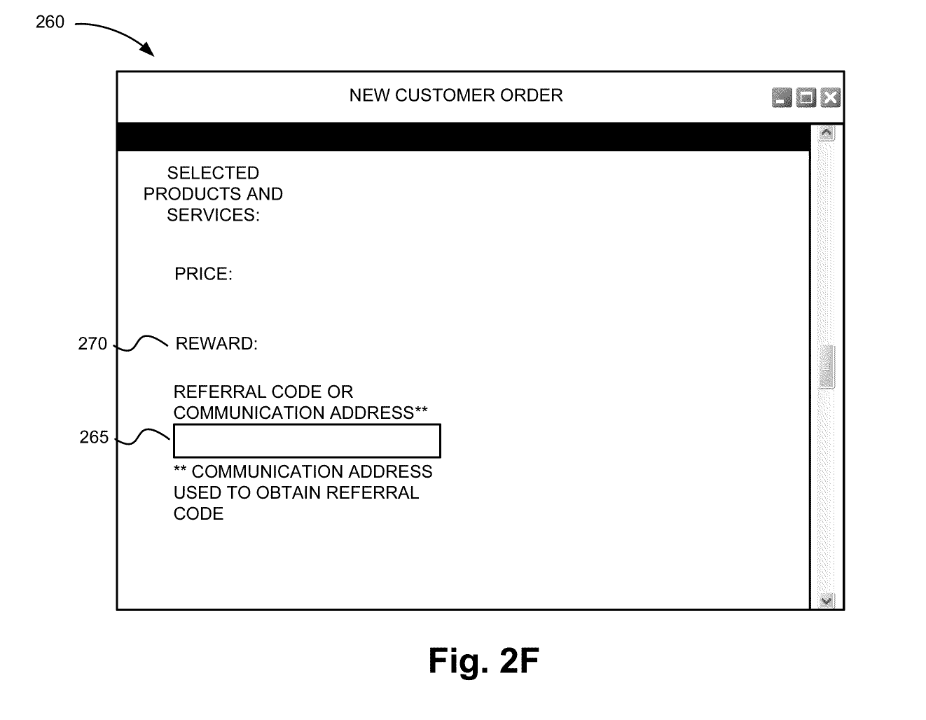

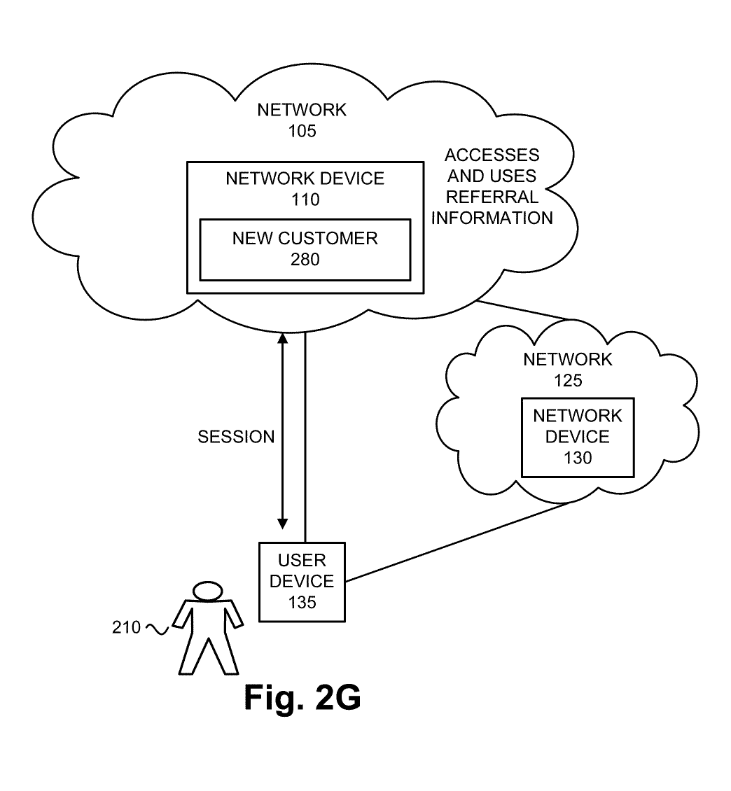

FIGS. 2A-2G are diagrams illustrating an exemplary referral process of a rewards program. According to an exemplary scenario, and referring to FIG. 2A, a user 205 logs in to network device 110 via user device 135. Subsequently, user 205 navigates to a rewards program graphical user interface provided by rewards program element 115. For example, as illustrated in FIG. 2B, a graphical user interface 210 allows user 205 to navigate via a rewards 215 menu and select a referral code menu 220. Referral code menu 220 allows user 205 to obtain a referral code. For example, a referral code box 225 is presented to user 205. User 205 enters a string of characters. Rewards program element 115 generates a referral code based on the entered string of characters. For example, rewards program element 115 performs a hashing function on the entered string. Referring to FIG. 2C, a graphical user interface 230 presents a referral code 235 (e.g., “Barnhill123SP”) to user 205. Additionally, for example, graphical user interface 230 includes a share referral code option 240. As illustrated, share referral code option 240 allows user 205 to share referral code 235 with a non-customer via various social media sites and e-mail. Although not illustrated, graphical user interface 230 may include instructions to the customer to provide a copy (to the service provider) of any message that includes the referral code and is sent to a non-customer. The instructions may also include communication addresses of the service provider that may be used to ensure the service provider receives a copy of any message.

Referring to FIG. 2D, user 205 may share referral code 235 via network 110 (e.g., via share referral code option 240). For example, user 205 may select one of the selectable icons (e.g., Facebook icon, Twitter icon, etc.) of share referral code option 240 to initiate a communication with a non-customer. Alternatively, user 205 may establish a connection with network device 130 (e.g., an e-mail server, a social media site, etc.) without using share referral code option 240 of graphical user interface 230. As an example, user 205 may visit a social media site (e.g., Facebook, Twitter, etc.) or launch an e-mail client to provide referral code 235 to a friend. In either case, user 205 sends a message to the non-customer and the service provider (e.g., carbon copies the service provider). As an example, the service provider may have various accounts and communication addresses for various social media sites (e.g., Facebook, Twitter, etc.). Additionally, for example, the service provider may have an e-mail address that can be used by user 205 to carbon copy an e-mail. As illustrated in FIG. 2D, rewards program element 115 obtains and stores referral information stemming from the communication between user 205 and the non-customer (e.g., user's 205 friend). An example of referral information is described below.

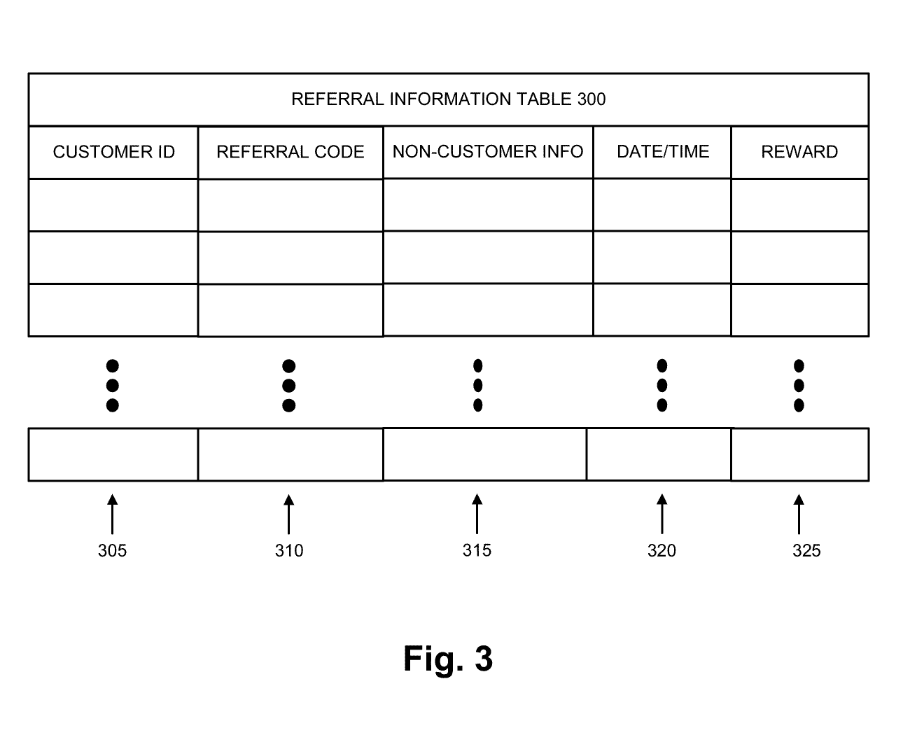

FIG. 3 is a diagram illustrating an exemplary referral information table 300 that stores exemplary referral information. As illustrated, table 300 includes a customer identifier field 305, a referral code field 310, a non-customer information field 315, a data and time field 320, and a reward field 325.

Customer identifier field 305 stores data that identifies the customer. For example, the data may indicate the customer's name, an e-mail address, or some other unique string that identifies the customer. Referral code field 310 stores data that indicates the referral code. For example, the data may be a hashed string or other type of sequence of characters.

Non-customer information field 315 stores data pertaining to the non-customer. For example, the data may indicate the non-customer's e-mail address, a user name of the non-customer that is associated with a social media site, the non-customer's name, etc.

Date and time field 320 stores data that indicates a date and timestamp pertaining to the communication from the customer to the non-customer. Reward field 325 stores data that indicates a reward. For example, the reward may be for the customer. Additionally, or alternatively, the reward may be for the non-customer when the non-customer subscribes to the service provider. As previously described, the rewards program may award various types of benefits, such as points, discounts on equipment and/or services, a free trial of a new service, credit to a bill, a gift card, donation to a charity, etc.

According to other implementations, table 300 may include additional fields, fewer fields, and/or different fields than those illustrated in FIG. 3 and described herein. For example, table 300 may include a field that indicates how many non-customers have been referred to by the customer, etc., which may be used to calculate the award.

Referring to 2E, assume the non-customer (e.g., user 250) receives the communication from user 205, and decides to subscribe to the service provider. For example, assume the service provider offers a television service, an Internet service, and a mobile service. User 250 establishes a web session with new customer element 280 of network device 110. New customer element 280 of network device 110 provides the functionality of creating an account, etc., as well as managing referrals, etc., as described herein. Subsequently, user 250 provides information to establish an account and selects a service plan. Referring to FIG. 2F, new customer element 280 provides a graphical user interface 260 that lists, among other items, the selected products and services and the price. Additionally, for example, graphical user interface 260 includes a referral code or communication address field 265. User 250 has the option to enter the referral code (e.g., referral code 235 (e.g., “Barnhill123SP”)) or a communication address used by user 205 to communicate with user 250 and provide the referral code. According to this scenario, assume user 250 is unable to recall the referral code and does not wish to locate the original message. Therefore, user 250 enters a communication address (e.g., user's 250 e-mail address) associated with an e-mail, which included the referral code, from user 205.

Based on the communication address, new customer element 280 accesses and uses the referral information stored, as illustrated in FIG. 2G. For example, new customer element 280 initiates a query to search non-customer information field 315. Upon finding a match between the communication address provided and a communication address stored in non-customer information field 315, new customer element 280 validates the referral. Additionally, new customer element 280 is able to identify the customer associated with the referral as well as other information (e.g., reward information, referral code, etc.). Based on this available information, new customer element 280 populates a reward 270 of graphical user interface 260 to indicate the reward conferred to user 250. For example, reward 270 may indicate that user 250 is provided with a discounted price.

The scenarios described in reference to FIGS. 2A-2G are exemplary. Various modifications to the referral process, as described in relation to FIGS. 2A-2G may be implemented. For example, although the referral process has been described in relation to network device 110, according to other embodiments, user 205 and/or user 250 may communicate with the service provider via a call center (e.g., via a telephone). For example, an agent may provide user 205 with a referral code. Additionally, for example, user 250 may become a new customer by speaking with an agent. During this process, user 250 may provide the referral code or a communication address (e.g., social media, e-mail, etc.) to the agent.

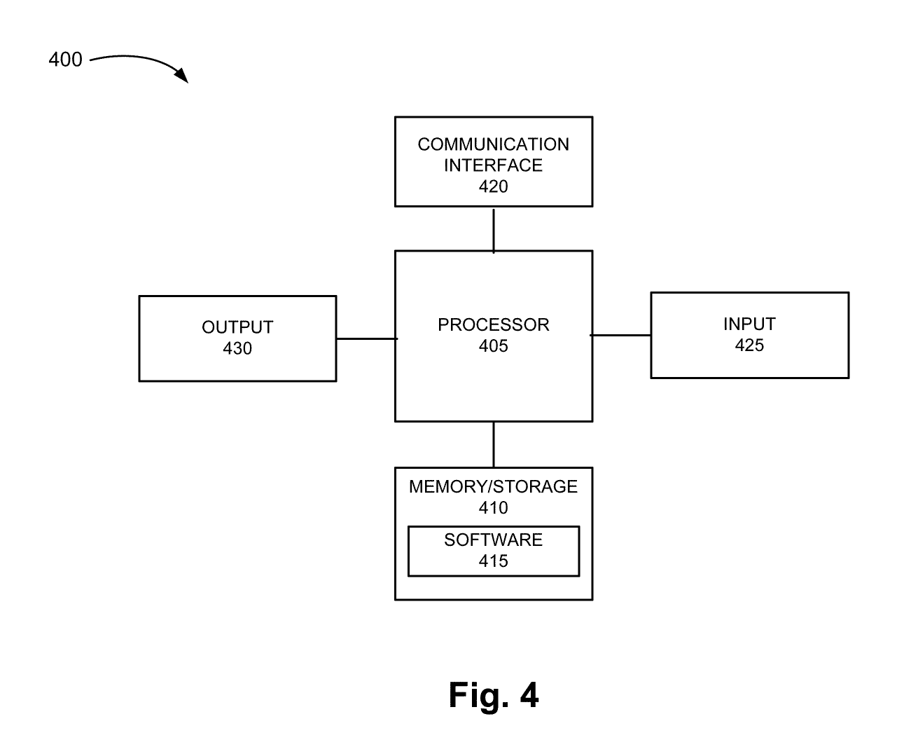

FIG. 4 is a diagram illustrating exemplary components of a device 400 that may correspond to one or more of the devices in environment 100. For example, device 400 may correspond to components included in network device 110, network device 130, and user device 135. As illustrated, device 400 includes a processor 405, a memory/storage 410 that stores software 415, a communication interface 420, an input 425, and an output 430. According to other implementations, device 400 may include fewer components, additional components, different components, and/or a different arrangement of components than those illustrated in FIG. 4 and described herein.

Processor 405 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 405 may be implemented as hardware (e.g., a microprocessor, etc.) or a combination of hardware and software (e.g., a SoC, an ASIC, etc.). Processor 405 may include one or multiple memories (e.g., memory/storage 410), etc.

Processor 405 may control the overall operation, or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., another device, a network, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 410 may include a hard disk (e.g., a magnetic disk, an optical disk, a magneto-optic disk, a solid state disk, etc.) and a corresponding drive. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 410 may store data, software, and/or instructions related to the operation of device 400

Software 415 includes an application or a program that provides a function and/or a process. Software 415 may include firmware. For example, with reference to network device 110, software 415 may include an application that, when executed by processor 405, provides the functions of rewards program element 115, as described herein. Additionally, software may include an application that, when executed by processor 405, provides the functions of new customer element 280, as described herein.

Communication interface 420 permits device 400 to communicate with other devices, networks, systems and/or the like. Communication interface 420 includes one or multiple wireless interface(s) and/or wired interface(s). For example, communication interface 420 may include one or multiple transmitter(s) and receiver(s), or transceiver(s).

Input 425 provides an input into device 400. For example, input 425 may include a keyboard, a keypad, a touchscreen, a touch pad, a touchless screen, a mouse, an input port, a button, a switch, a microphone, a knob, and/or some other type of input.

Output 430 provides an output from device 400. For example, output 430 may include a display, a speaker, a light (e.g., light emitting diode(s), etc.), an output port, a vibratory mechanism, and/or some other type of output.

Device 400 may perform a function or a process in response to processor 405 executing software instructions stored by memory/storage 410. For example, the software instructions may be read into memory/storage 410 from another memory/storage 410 or read from another device via communication interface 420. The software instructions stored in memory/storage 410 may cause processor 405 to perform processes described herein. Alternatively, according to another implementation, device 400 may perform a process or a function based on the execution of hardware (e.g., processor 405, etc.).

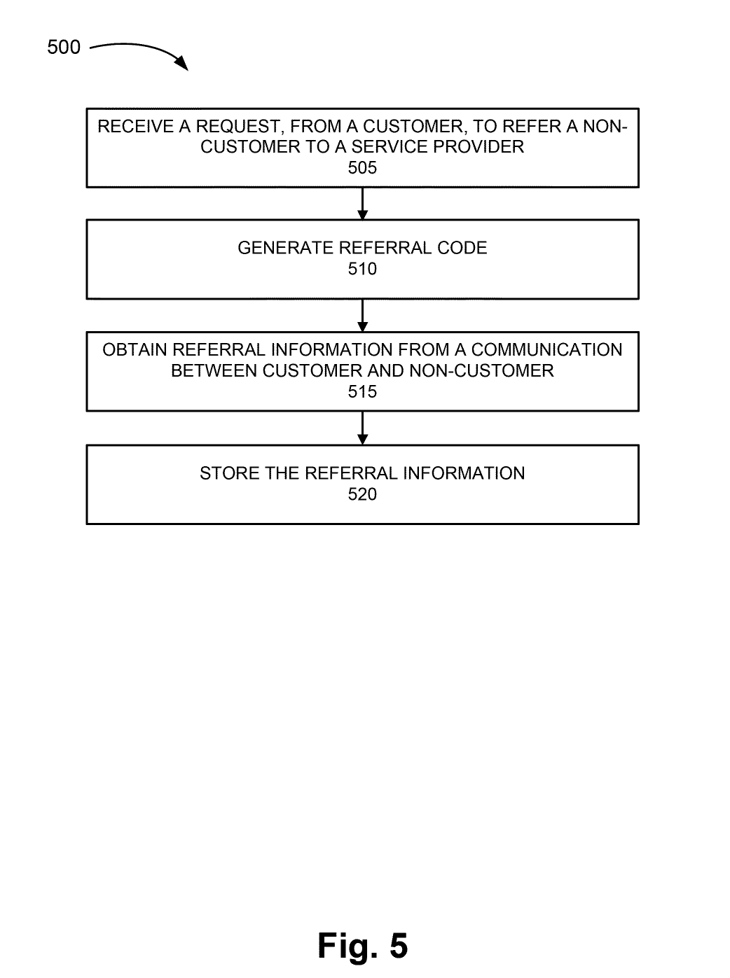

FIG. 5 is a flow diagram illustrating an exemplary referral process 500. Process 500 is directed to the embodiment, previously described above with respect to FIGS. 2A-2D, as well as elsewhere in this description, in which a rewards program includes providing a referral code to a customer and obtaining referral information based on a communication between the customer and a non-customer. According to an exemplary embodiment, one or more operations of process 500 are performed by rewards program element 115. For example, the functionality of rewards program element 115 may be implemented by processor 405 executing software 415.

Referring to FIG. 5, in block 505, process 500 may begin with receiving a request, from a customer, to refer a non-customer to a service provider. For example, rewards program element 115 of network device 110 provides graphical user interface 210 that allows a customer to refer a non-customer to the service provider. As previously described, the referral service may be a part of a rewards program offered by the service provider to its customers.

In block 510, a referral code is generated. For example, rewards program element 115 generates a referral code. For example, the customer may enter a seed (e.g., a string) in referral code box 225 of graphical user interface 210. Based on the entered string, rewards program element 115 generates a referral code and presents the referral code via a graphical user interface 230. In other embodiments, the referral code is randomly or pseudo-randomly generated by rewards program element 115.

In block 515, referral information is obtained from a communication between the customer and the non-customer. For example, the customer may initiate a communication with a non-customer via graphical user interface 230 (e.g., share referral code option 240). Alternatively, the customer may initiate a communication with the non-customer via user device 135 and network device 130. For example, the customer may use an e-mail client to author an e-mail to the non-customer. Alternatively, the customer may use a browser or other application to author a message to the non-customer via a social media-based form of communication. In either example, the message includes the referral code. Additionally, as previously described, the customer also provides the service provider with a copy of the message (e.g., carbon copies).

In block 520, the referral information is stored. For example, based on receiving the message, rewards program element 115 obtains referral information. For example, rewards program element 115 extracts certain referral information from the message (e.g., sender, receiver, referral code, date and time, etc.). Rewards program element 115 stores the referral information in a database or some type of data structure (e.g., table 300). Process 500 ends.

Although FIG. 5 illustrates an exemplary process 500, according to other implementations, process 500 may include additional operations, fewer operations, and/or different operations than those illustrated in FIG. 5, and described herein.

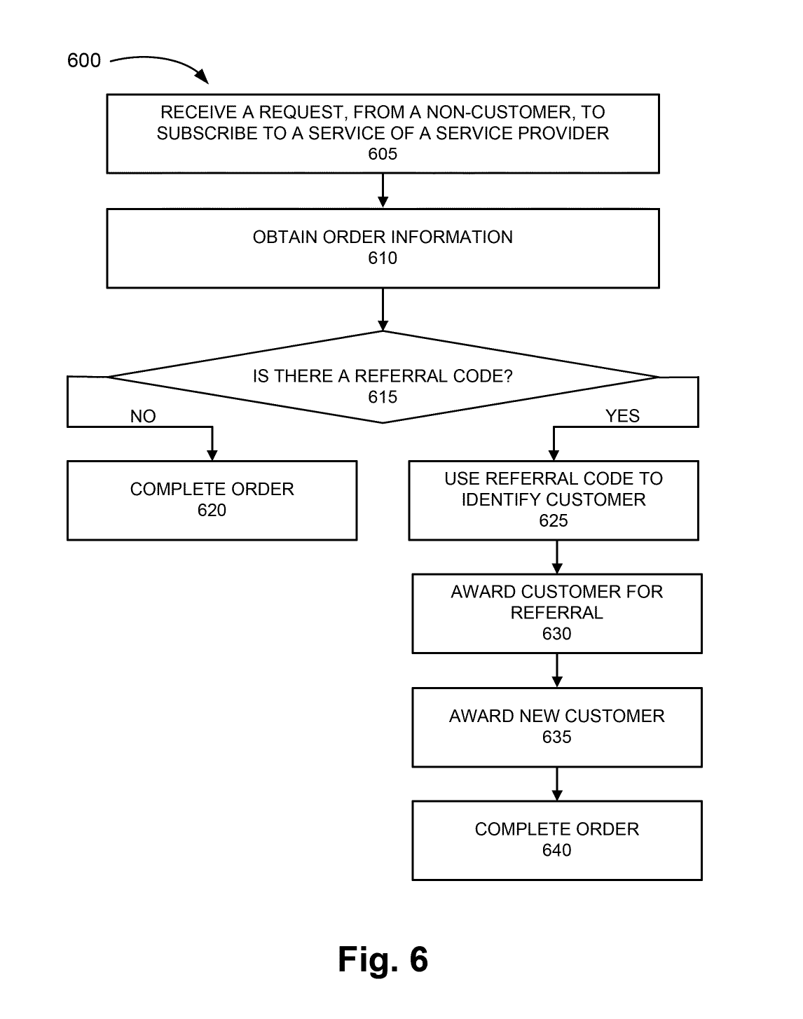

FIG. 6 is a flow diagram illustrating another exemplary referral process 600. Process 600 is directed to the embodiment, previously described above with respect to FIGS. 2E-2G, as well as elsewhere in this description, in which a network device uses referral information to validate a referral by a customer and assign a reward associated with a rewards program. According to an exemplary embodiment, one or more operations of process 600 are performed by network device 110. For example, the functionality of new customer element 280 may be implemented by processor 405 executing software 415.

Referring to FIG. 6, in block 605, process 600 may begin with receiving a request, from a non-customer, to subscribe to a service of a service provider. For example, new customer element 280 of network device 110 provides a graphical user interface that allows the non-customer to request to subscribe to the service of the service provider. In block 610, order information is obtained. For example, new customer element 280 of network device 110 provides a graphical user interface that allows the non-customer to enter personal information, select the service, etc. During a confirming of the order, new customer element 280 may provide a graphical user interface, such as graphical user interface 260. As previously described, the non-customer may enter (e.g., in referral code or communication address field 265) a referral code or another referent (e.g., communication address).

In block 615, it may be determined whether there is a referral code associated with the non-customer. For example, new customer element 280 may determine whether any information has been entered by the non-customer in referral code or communication address field 265. If it is determined that there is not a referral code (block 615—NO), then the order is completed (block 620). For example, if referral code or communication address field 265 is left blank, then new customer element 280 continues with completion of the order and subscription of the non-customer. Process 600 ends.

If it is determined that there is a referral code (block 615—YES), then the referral code is used to identify the customer (block 625). For example, new customer element 280 validates the information included in referral code or communication address field 265. New customer element 280 may inspect the information to determine whether the information corresponds to a potential referral code or another type of referent. For example, new customer element 280 may use various methods, such as string length, type of characters included in the information, etc. As previously described, new customer element 280 may search table 300 (e.g., referral code field 310 or non-customer information field 315) to validate the information.

If the referral code or the referent is not found, new customer element 280 informs the non-customer. The non-customer may choose to enter new information, fix any errors, etc., or continue without this information. However, if the referral code or the referent is found, new customer identifies the customer that is responsible for the referral. For example, new customer element 280 correlates the referral code or the referent to customer identifier field 305.

In block 630, an award is provided to the existing customer. For example, new customer element 280 determines the award earned by the customer based on the data stored in reward field 325. New customer element 280 initiates an award process on behalf of the identified customer.

In block 635, an award is provided to the new customer. For example, new customer element 280 determines the award afforded to the non-customer based on the data stored in reward field 325. Reward 270 of graphical user interface 260 presents the reward information to the non-customer. In block 640, the order is completed. For example, new customer element 280 continues with completion of the order and subscription of the non-customer.

Although FIG. 6 illustrates an exemplary process 600, according to other implementations, process 60 may include additional operations, fewer operations, and/or different operations than those illustrated in FIG. 6, and described herein. For example, in block 630, new customer element 280 may determine the award earned by the customer based on other data stored in referral information table 300. For example, depending on the number of non-customers to which the message is sent, new customer element 280 uses this as a factor to determine the award. By way of further example, if the customer sends the message that includes the referral code to five non-customers, new customer element 280 will assign a greater award to the customer compared to if the customer sends the message to only one non-customer. In this regard, since the behavior of the customer and his or her efforts are known by way of having a copy of the message, the service provider extends further benefits to the customer for his or her efforts. Other reward schemes may be used based on the referral information. For example, new customer element 280 may allow the customer to select a reward from among multiple rewards. The number of rewards, the type and/or value associated with each reward may be different depending on factors, such as the number of non-customers to which the message is sent, the number of non-customers that have subscribed or purchased a service thus far, etc.

The foregoing description of implementations provides illustration, but is not intended to be exhaustive or to limit the implementations to the precise form disclosed. Accordingly, modifications to the implementations described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks are described with regard to the processes illustrated in FIGS. 5 and 6, the order of the blocks may be modified in other implementations. Further, non-dependent blocks may be performed in parallel. Additionally, with respect to other processes described in this description, the order of operations may be different according to other implementations, and/or operations may be performed in parallel.

The embodiments described herein may be implemented in many different forms of software and/or firmware executed by hardware. For example, a process or a function may be implemented as “logic” or as a “component.” The logic or the component may include, for example, hardware (e.g., processor 405, etc.), or a combination of hardware and software (e.g., software 415). The embodiments have been described without reference to the specific software code since software can be designed to implement the embodiments based on the description herein.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 405) of a computational device. A non-transitory storage medium includes one or more of the storage mediums described in relation to memory/storage 410.

To the extent the aforementioned embodiments collect, store or use personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, operation, or instruction described in the present application should be construed as critical or essential to the embodiments described herein unless explicitly described as such.

What is claimed is:

1. A method comprising:
receiving, by a device, a referral request from a customer of a service provider;
generating, by the device, a referral code based on the receiving;
receiving, by the device, a message from the customer to a non-customer, wherein the message includes the referral code; and
storing, by the device, referral information included in the message, wherein the referral information includes a communication address of the non-customer, the referral code, and a communication address of the customer.

2. The method of claim 1, further comprising:
receiving, by the device, a request from the non-customer to subscribe to a service offered by the service provider;
requesting, by the device, the referral code or a referent of the referral code from the non-customer;
obtaining, by the device, the referral code or the referent; and
determining, by the device, whether the referral code or the referent is valid.

3. The method of claim 2, further comprising:
assigning a reward to the customer based on determining that the referral code or the referent is valid.

4. The method of claim 2, further comprising:
assigning a reward to the non-customer based on determining that the referral code or the referent is valid.

5. The method of claim 2, further comprising:
determining the customer based on a correlation between an identifier of the customer and the referral code or the referent; and
determining a reward based on a correlation between the referent and the referral code.

6. The method of claim 2, wherein the referent is the communication address of the non-customer included in the message.

7. The method of claim 2, further comprising:
receiving a string from the non-customer based on the requesting; and
determining whether the string is the referral code or the referent.

8. A device comprising:
a communication interface;
a memory, wherein the memory stores instructions; and
a processor, wherein the processor executes the instructions to:
receive, via the communication interface, a referral request from a customer of a service provider;
generate a referral code based on a receipt of the referral request;
receive a message from the customer to a non-customer, wherein the message includes the referral code; and
store referral information included in the message, wherein the referral information includes a communication address of the non-customer, the referral code, and a communication address of the customer.

9. The device of claim 8, wherein processor further executes the instructions to:
receive, via the communication interface, a request from the non-customer to subscribe to a service offered by the service provider;
request the referral code or a referent of the referral code from the non-customer;
obtain the referral code or the referent; and
determine whether the referral code or the referent is valid.

10. The device of claim 9, wherein the processor further executes the instructions to:
assign a reward to the customer based on a determination that the referral code or the referent is valid, wherein the reward is based on a number of non-customers to which the message is sent.

11. The device of claim 9, wherein the processor further executes the instructions to:
assigning a reward to the non-customer based on a determination that the referral code or the referent is valid.

12. The device of claim 9, wherein the processor further executes the instructions to:
determine the customer based on a correlation between an identifier of the customer and the referral code or the referent; and
determine a reward based on a correlation between the referent and the referral code.

13. The device of claim 9, wherein the referent is the communication address of the non-customer included in the message.

14. The device of claim 9, wherein the processor further executes the instructions to:
receive, via the communication interface, a string from the non-customer based on a request of the referral code; and
determine whether the string is the referral code or the referent.

15. The device of claim 8, wherein the processor further executes the instructions to:
offer a rewards program service to customers, wherein the rewards program includes a referral service that provides awards to the customers when non-customers subscribe to the service provider based upon receiving referral codes from the customers.

16. A non-transitory storage medium comprising instructions executable by a processor of a computational device, which when executed by the processor, cause the computational device to:
receive, via a first graphical user interface, a referral request from a customer of a service provider;
generate a referral code based on a receipt of the referral request;
receive a message from the customer to a non-customer, wherein the message includes the referral code; and
store referral information included in the message, wherein the referral information includes a communication address of the non-customer, the referral code, and a communication address of the customer.

17. The non-transitory storage medium of claim 16, further comprising instructions, which when executed by the processor, cause the computational device to:
receive, via a second graphical user interface, a request from the non-customer to subscribe to a service offered by the service provider;
request the referral code or a referent of the referral code from the non-customer;
obtain the referral code or the referent; and
determine whether the referral code or the referent is valid.

18. The non-transitory storage medium of claim 17, further comprising instructions, which when executed by the processor, cause the computational device to:
assign a reward to the customer based on a determination that the referral code or the referent is valid.

19. The non-transitory storage medium of claim 17, further comprising instructions, which when executed by the processor, cause the computational device to:
determine the customer based on a correlation between an identifier of the customer and the referral code or the referent; and
determine a reward based on a correlation between the referent and the referral code.

20. The non-transitory storage medium of claim 17, further comprising instructions, which when executed by the processor, cause the computational device to:
receive, via the second graphical user interface, a string from the non-customer based on a request of the referral code; and
determine whether the string is the referral code or the referent.
